(19) United States
(12) Patent Application Publication
(10) Pub. No.: US 2007/0068250 A1
(43) Pub. Date: Mar. 29, 2007

(54) Measuring cups

(76) Inventor: Adam Krent, Brooklyn, NY (US)

Correspondence Address: Andre M. Szuwalski;JENKENS & GILCHRIST, A PROFESSIONAL CORPORATION, Suite 3700, 1445 Ross Avenue, Dallas, TX, 75202, US

(21) Appl. No.: 11/238,935

(22) Filed: Sep. 29, 2005

(51) Int. Cl. G01F 19/00

(52) U.S. Cl. 73/427

(57) ABSTRACT

A measuring cup for allowing a user to determine the volume and/or level of contents within the measuring cup by looking from above. The measuring cup including a bottom wall, a generally circularly shaped upstanding encircling side wall having a bottom edge and an open upper end. The measuring cup further includes a plurality of steps formed integrally with an inner surface of the side wall, each of the plurality of steps being non-vertically aligned, horizontally spaced apart, and independently radially aligned.

### BACKGROUND OF THE INVENTION

1. Technical Field

The present invention relates in general to measuring cups. In particular, the present invention relates to a measuring cup which includes volumetric indicia visible from above the measuring cup or from an elevated view while pouring liquid or powdered material into or from the measuring cup.

1. History of Related Art

Measuring cups are well known. The utility derived from a measuring cup is related to the ease with which volumetric indicia on a wall of the measuring cup may be read by a user. Any suitable units of measurements may be used to indicate a level to which contents have risen within the measuring cup.

Traditionally, measuring cups have volume indicia marked along an exterior side of the measuring cup. However, this marking system is inconvenient when a user is attempting to pour partial amounts of material from the measuring cup or when the user is attempting to partially fill the measuring cup. The most precise way to measure the contents contained therein is to place the measuring cup upon a level surface, pour the contents to be measured into the measuring cup and then stoop down to the vertical level of the measuring cup to attempt to visually detect a bottom of a liquid meniscus or to a level surface of the powdered material. In an alternate method, in order to read the level to which contents in a measuring cup have risen, one may lift the measuring cup to eye level and attempt to hold the measuring cup steady while visually detecting the volume. In either case, the user is looking in a generally horizontal direction to detect the volume and achieving an accurate volume measurement of the contents within the measuring cup can be uncomfortable and time consuming.

Other known measuring cups have volumetric indicia marked on an inside surface of the measuring cup. However, since the volumetric indicia are on a vertical wall of the measuring cup, they are difficult to read from a normal standing position, while the measuring cup is on a countertop or work surface. In order to accurately view the desired volume indicia, the user may be required to stoop down and get their eyes closer to the measuring cup or closer to the surface of the countertop.

Measuring the volume of fluids or cooking ingredients using prior art measuring cups can be frustrating. As mentioned above, it can be difficult for the user to stoop down to read the level of contents when the measuring cup is placed on a level surface or when lifted to eye level. In addition, an unsteady hand not only makes the volume of contents difficult to determine when the measuring cup is lifted to eye level but the user may also spill contents or even drop the measuring cup when attempting to do so.

Therefore, there is a need for an improved measuring cup which allows a user to determine the volume and/or level of contents within the measuring cup by looking from above along with being simple and inexpensive to manufacture.

### SUMMARY OF THE INVENTION

A measuring cup includes a bottom wall, an upstanding encircling side wall having a bottom edge and an open upper end and a plurality of steps formed integrally with an inner surface of the side wall, each of the plurality of steps being non-vertically aligned.

A measuring cup includes a bottom wall, an upstanding encircling side wall having a bottom edge and an open upper end with a generally circularly shaped rim. The measuring cup further includes a plurality of steps being independently radially aligned on an inner surface of the side wall, wherein each of the plurality of steps further including a horizontal upwardly formed surface marked with a volume indicia so as to be observable by a user looking downwardly towards the open upper end.

A measuring cup includes a bottom wall connected to an upstanding encircling side wall to form an open upper end with an ellipsoidal rim defining a first and second corners. The measuring cup further includes a plurality of horizontally spaced apart steps formed integrally with an inner surface of the side wall, wherein the plurality of horizontally spaced apart steps are not formed on either the first and second corners.

A measuring cup includes a bottom wall, a generally circular upstanding encircling side wall having a bottom edge and a generally circularly shaped open upper end and a plurality of steps formed integrally with an inner surface of the side wall, all of the plurality of steps being independently radially aligned.

A measuring cup includes a bottom wall, a generally circular upstanding encircling side wall having a bottom edge and an open upper end, and a plurality of steps formed integrally with an inner surface of the side wall, each of the plurality of steps being horizontally spaced apart.

A measuring cup includes a generally circularly shaped upstanding encircling side wall having a bottom edge and an open upper end. The measuring cup further includes a plurality of steps formed integrally with an inner surface of the side wall, each of the plurality of steps being non-vertically aligned and a bottom wall including a plurality of cut out portions, each of the plurality of cut out portions aligned with a corresponding one of the plurality of steps.

### BRIEF DESCRIPTION OF THE DRAWINGS

A more complete understanding of the present invention may be obtained by reference to the following Detailed Description of Illustrative Embodiments of the Invention, when taken in conjunction with the accompanying Drawings, wherein:

FIG. 1 is a perspective view of the measuring cup according to the present invention;

FIG. 2 is a top plan view of the measuring cup according to the present invention;

FIG. 3 illustrates a perspective cross-sectional view taken along line A-A of FIG. 2;

FIG. 4 illustrates a perspective cross-sectional view taken along line B-B of FIG. 2;

FIG. 5 is a side view of the measuring cup according to the present invention;

FIG. 6A is a side view of the measuring cup according to an alternate embodiment of the present invention;

FIG. 6B is a side view of the measuring cup according to an alternate embodiment of the present invention;

FIG. 7 is a bottom plan view of the measuring cup according to the present invention;

FIG. 8 is a perspective view of the measuring cup according to an alternate embodiment of the present invention; and

FIG. 9 is a perspective view of the measuring cup according to an alternate embodiment of the present invention.

### DETAILED DESCRIPTION OF ILLUSTRATIVE

### EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims and the equivalents thereof.

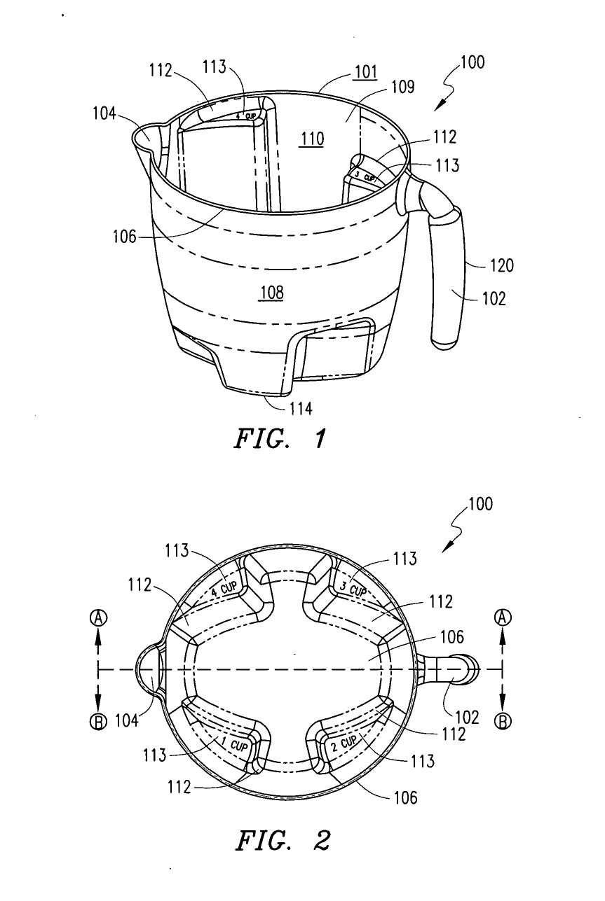

With reference now to the drawings, and in particular to FIGS. 1-9 thereof, a novel measuring cup embodying the principles and concepts of the present invention and generally designated by the reference numeral 100 will be described. While the embodiments described herein are identified as an exemplary measuring cup 100 having volumetric markings visible from above the measuring cup 100 for use during measuring the volume of liquids, it will be appreciated by those skilled in the art that the present invention is not limited to measuring the volume of liquids, and may include measuring the volume and/or level of solid (for example, powdered) materials.

Referring now to FIGS. 1-7, an embodiment of the measuring cup 100 of the present invention will be described.

The measuring cup 100 includes a unitary, one piece wall structure 101 formed of a light-transmitting material and including an upstanding encircling side wall 109, which has an outer surface 108 and an inner surface 110 and a generally circularly shaped perimeter. Formed on the side wall 109 at an upper rim thereof is a spout 104 and extending outwardly and downwardly from the upper rim of the side wall 109 at a location diametrically opposite the spout 104 is a handle 102. According to an exemplary embodiment, the handle 102 is preferably covered with a rubber or other polymer coating 120 for gripping purposes. The handle 102 may also be covered by a grip sheath 120, preferably formed of a suitable flexible and cushioning elastomeric material such as that sold under the trademark name SANTOPRENE®. This provides a comfortable, non-slip, frictional grip surface to facilitate grasping of the handle 102. The measuring cup 100 has a base or a bottom wall 114 integrally attached around its perimeter to the bottom edge of the side wall 109. The side wall 109 cooperates with the bottom wall 114 to form a cup-like structure which has an open upper end.

According to an embodiment of the present invention, the measuring cup 100 is molded from any suitable food graded plastic known in the art. However, it will be appreciated that the measuring cup 100 according to the present invention can be manufactured by any suitable process. According to an exemplary embodiment, the measuring cup 100 may be formed from a variety of different transparent or translucent materials known in the art such as, for example, the material sold under the trademark PYREX®.

The inner surface 110 of the side wall 109 further includes a plurality of steps shown generally by reference numeral 112. Each of the plurality of steps 112 includes a horizontal upwardly facing surface 113. The plurality of steps 112 can be placed at any location on the inner surface 110 of the side wall 109 but are preferably independently radially aligned with respect to each other (such that they are preferably horizontally spaced apart and non-vertically aligned). The plurality of steps 112 provide for a uniform flow of the liquid when poured out of the measuring cup 100. The horizontal surface 113 of the steps 112 are each marked with a volume indicia such that a user may easily look down towards the measuring cup 100 from above and view the volume and/or level of the contents within the measuring cup 100. According to an embodiment of the present invention, the steps 112 may be provided with metric indicia on the horizontal surface 113 or standard English indicia.

In use, the measuring cup 100 is adapted to determine an accurate measurement of the amount of contents within the measuring cup 100 while looking from above. In order to fill the measuring cup 100 in an accurate, partial-fill amount such as, for example, one quarter, one half, three quarter, one, one and one quarter, one and one half, one and three quarter, or two cups, all a user is required to do is to place the measuring cup 100 on a horizontal surface (work surface), and fill the measuring cup 100, looking from above until the steps 112 with the indicia for the desired volume metric amount begins to be covered with the material. The material may be, for example, in liquid or powdered form. Thus, the user does not need to stoop down and view the measuring cup 100 from the side or otherwise lower their head to a level of the work surface.

FIG. 2 illustrates a top view of the measuring cup 100. FIG. 2 further illustrates the plurality of steps 112 that are independently radially aligned with respect to each other (here illustrating that they are horizontally spaced apart). In addition, FIG. 2 further illustrates the horizontal surface 113 of the steps 112 that are marked with a volume indicia such that a user may easily look down towards the measuring cup 100 from above and view the volume and/or level of the contents within the measuring cup 100.

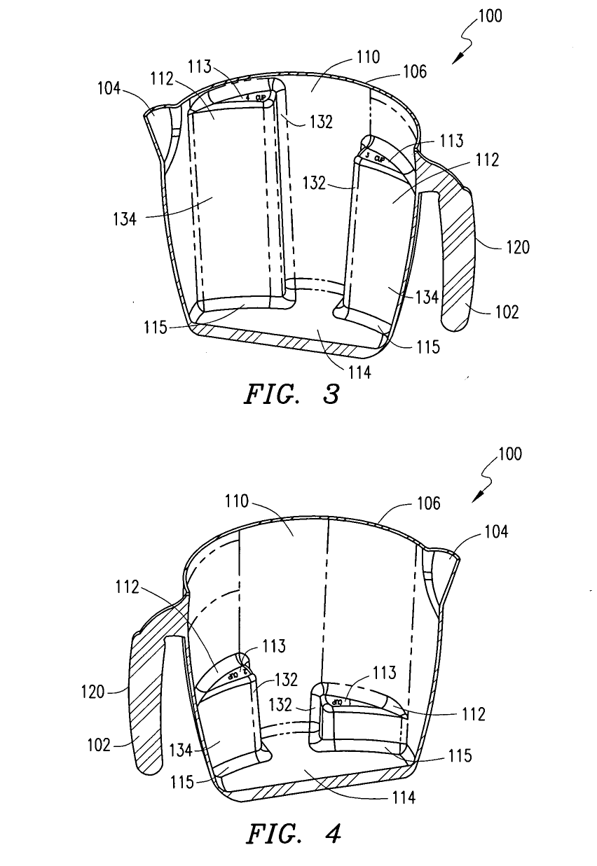

FIG. 3 illustrates a cross-sectional view taken along line A-A of FIG. 2. In this view the cross section is taken of the measuring cup 100 along the central region. FIG. 3 provides a detailed illustration of the steps 112. The steps 112 are of different heights and include a horizontal surface 113 marked with a volume indicia. The plurality of steps 112 further include a base or a bottom end 115. The bottom end 115 is located proximate the bottom wall 114 of the measuring cup 100. The different heights of the steps 112 are adapted to provide volumetric measurements of the contents within the measuring cup 100. The steps 112 are independently radially aligned (here illustrating that they are non-vertically aligned). The plurality of steps 112 further comprise a plurality of substantially vertical side walls 132 and 134. The plurality of side walls 132 and 134 and the horizontal surface 113 are integrally attached. According to an embodiment of the present invention, the plurality of steps 112 are shown as being generally triangular in shape, however, the steps 112 can be any other shape for volumetric measurements such as, for example, square, semi-circular or the like. As an exemplary embodiment, the horizontal surface 113 of the steps 112 are marked with a volume indicia such as, for example, 3 cups and 4 cups. According to another exemplary embodiment, the steps 112 may be provided with metric indicia or any other indicia that is capable of providing volumetric measurements within the measuring cup 100 on the horizontal surface 113 of the steps 112.

FIG. 4 illustrates a cross-sectional view taken along line B-B of FIG. 2. In this view the cross section is taken of the measuring cup 100 along the central region. FIG. 4 provides a detailed illustration of the steps 112. The steps 112 are of different heights and include a horizontal surface 113 marked with a volume indicia. The plurality of steps 112 further include a base or a bottom end 115. The bottom end 115 is located proximate the bottom wall 114 of the measuring cup 100. The different heights of the steps 112 are adapted to provide volumetric measurements of the contents within the measuring cup 100. The steps 112 are independently radially aligned (here illustrating that they are non-vertically aligned). The plurality of steps 112 further comprise a plurality of substantially vertical side walls 132 and 134. The plurality of side walls 132 and 134 and the horizontal surface 113 are integrally attached. As an exemplary embodiment, the horizontal surface 113 of the steps 112 are marked with a volume indicia such as, for example, 1 cup and 2 cups. According to another exemplary embodiment, the steps 112 may be provided with metric indicia or any other indicia that is capable of providing volumetric measurements within the measuring cup 100 on the horizontal surface 113 of the steps 112.

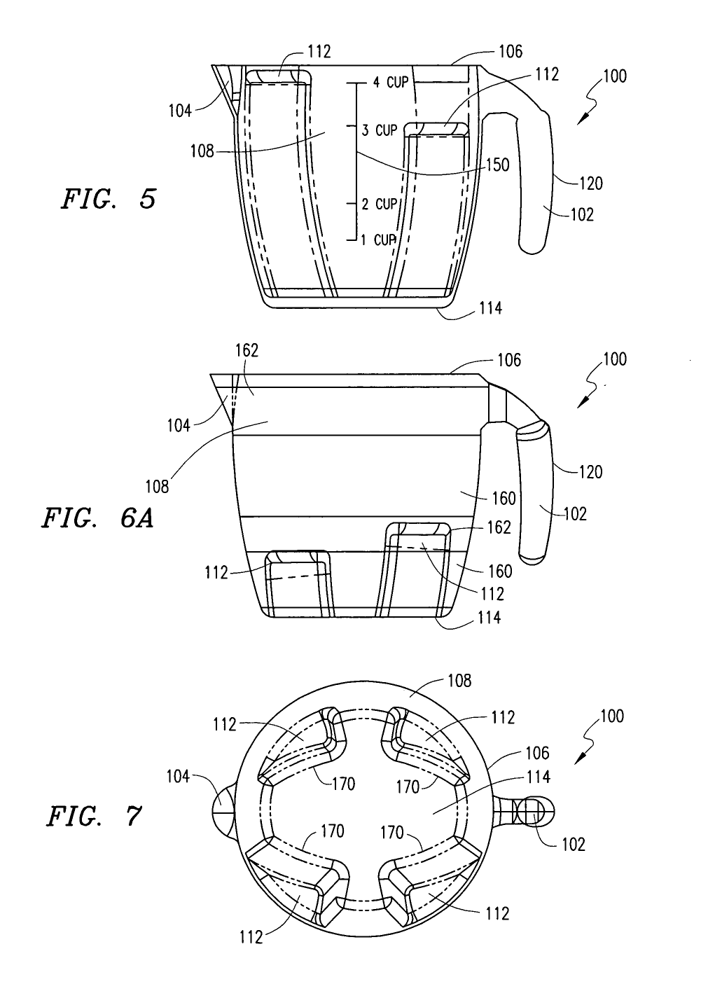

FIG. 5 illustrates a side view of the measuring cup in accordance with an embodiment of the present invention. The measuring cup 100 is formed of a transparent material such as the material known in the art under the trademark PYREX®. According to an exemplary embodiment of the present invention, the side wall 109 further includes a plurality of measuring indicia shown at 150 disposed on an outer surface 108 of the side wall 109.

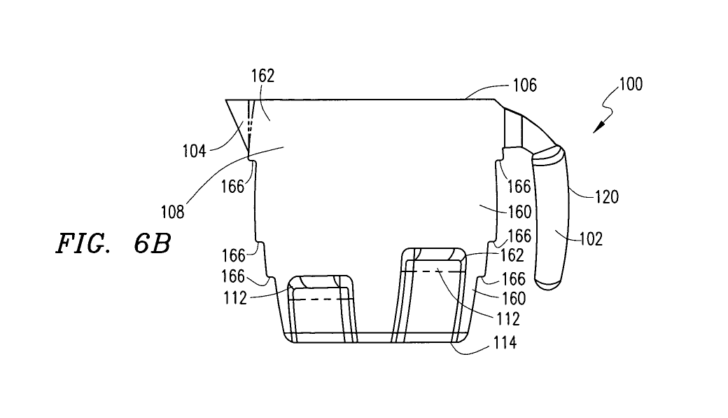

FIG. 6A illustrates a side view of the measuring cup in accordance with an alternate embodiment of the present invention. The measuring cup 100 is formed of a transparent material known in the art, however, the outer surface 108 of the side wall 109 includes a plurality of circumferential bands 160 and 162. The band 160 on the outer surface 108 of the side wall 109 is defined by having a matt finish while the band 162 on the outer surface 108 of the side wall 109 is defined by having a polished finish. The alternating bands 160 and 162 on the outer surface 108 of the side wall 109 are configured such that a band 160 or 162 is aligned with the horizontal surface 113 of each of the plurality of steps 112. This enables a user to determine the volume and/or level of contents within the measuring cup 100 by looking generally in a horizontal direction and aligning the meniscus or top surface of the material with the intersection line between the bands 160 and 162.

FIG. 6B illustrates a side view of the measuring cup in accordance with an alternate embodiment of the present invention. The measuring cup 100 is formed of a transparent material known in the art, however, the outer surface 108 of the side wall 109 includes a plurality of horizontal ledges 166 formed at different levels. More specifically, the plurality of horizontal ledges 166 are configured such they are aligned with the horizontal surface 113 of each of the plurality of steps 112. This enables a user to determine the volume and/or level of contents within the measuring cup 100 by looking generally in a horizontal direction.

FIG. 7 illustrates a bottom view of the measuring cup 100 in accordance with the present invention. FIG. 7 illustrates a bottom wall 114 having a generally circularly shaped perimeter with a plurality of cut out portions 170 to accommodate portions of the plurality of vertical side walls 132 and 134 of the plurality of steps 112. The plurality of vertical side walls 132 and 134 of the plurality of steps 112 terminate at the cut out portions 170 of the bottom wall 114 of the measuring cup. The bottom wall 114 of the measuring cup 100 is sized to provide stability for the measuring cup 100.

According to embodiments of the present invention, a measuring cup 100 having a side wall 109 with a substantially circularly shaped perimeter has been disclosed. It should be emphasized that the term “substantially circularly shaped”, when used herein refer to refer to the perimeter or rim shape, refers to suitable conic sections and may include, for example, a circular, an ellipsoidal, and an ovular shaped measuring cup 100. The measuring cup 100 can be manufactured in various sizes and shapes. As an exemplary embodiment, a variation of the measuring cup 100 having a substantially ovular wall/rim shape is illustrated in FIG. 8.

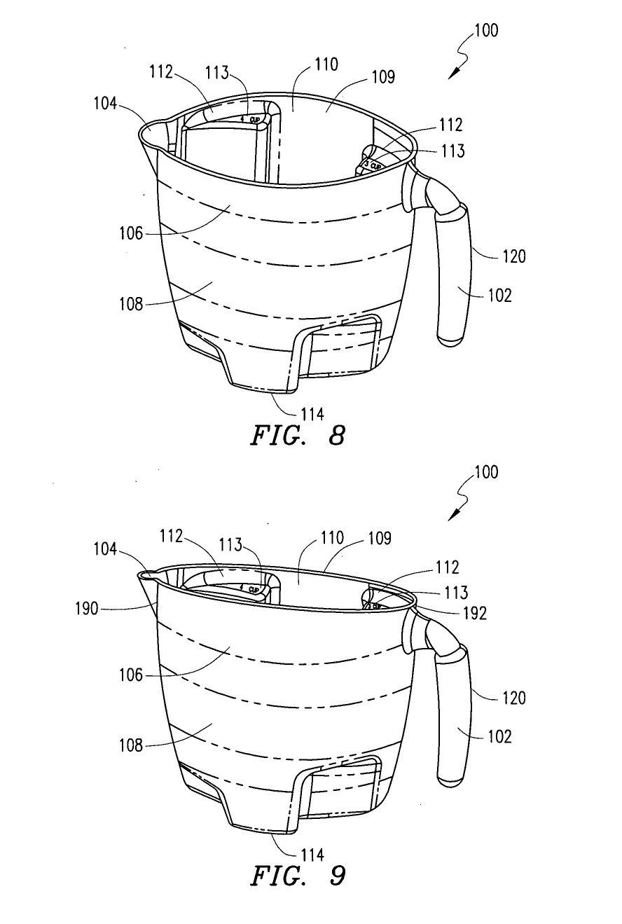

According to embodiments of the present invention, a measuring cup having a substantially ellipsoidal wall/rim shape is illustrated in FIG. 9. The measuring cup 100 as illustrated in FIG. 9 is similar to the ones disclosed earlier with respect to FIG. 1-8, however, the perimeter of the ellipsoidal measuring cup of FIG. 9 comprises a first corner 190 and a second corner 192 formed in wall 109 and by the side. The first corner 190 forms the spout 104 while a handle 102 is located at the second corner 192. The plurality of steps 112 can be placed at any location on the inner surface 110 of the side wall 109 except the corners 190 and 192. The plurality of steps 112 are independently radially aligned with respect to each other (as discussed, horizontally spaced apart and non-vertically aligned).

While in the disclosed embodiments a measuring cup 100 is disclosed as including four steps 112, any number of steps 112 can be used for the purpose of measuring the volume and/or level of contents within the measuring cup 100 while viewing from above. Preferably, the entire measuring cup 100 is formed from a transparent material, however, the steps 112 can be formed from a translucent material to enhance contrast with the side wall 109 of the measuring cup 100. Alternatively, the horizontal surface 113 of each surface may be opaque.

While the illustrated embodiments are described as a measuring cup 100, it will be appreciated that the principles of the present invention can be applied to other vessels such as, for example, bowls, ladles, and the like, to any vessel defining structure whether or not provided with a handle or spout, and of any other size or shape, which could utilize volume measuring indicia.

It should be emphasized that the terms “comprise”, “comprises”, and “comprising”, when used herein, are taken to specify the presence of stated features, integers, steps, or components, but do not preclude the presence or addition of one or more other features, integers, steps, components or groups thereof. The previous Detailed Description is of embodiment(s) of the invention. The scope of the invention should not necessarily be limited by this Description. The scope of the invention is instead defined by the following claims and the equivalents thereof.

What is claimed is:

1. A measuring cup comprising:
a bottom wall;
an upstanding encircling side wall having a bottom edge and an open upper end; and
a plurality of steps formed integrally with an inner surface of the side wall, each of the plurality of steps being non-vertically aligned.

2. The measuring cup of claim 1, wherein each of the plurality of steps comprise a horizontal upwardly forming surface marked with a volume indicia.

3. The measuring cup of claim 1, further comprising:
a spout attached integrally to the side wall; and
a handle attached integrally to the side wall and disposed substantially diametrically opposite the spout.

4. The measuring cup of claim 1, wherein a rim of the side wall is substantially circular in shape.

5. The measuring cup of claim 4, wherein the rim of the side wall is substantially elliptical in shape.

6. The measuring cup of claim 4, wherein the rim of the side wall is substantially ovular in shape.

7. The measuring cup of claim 1, wherein the bottom wall includes a plurality of cut out portions, each one aligned with a corresponding one of the plurality of steps.

8. The measuring cup of claim 1, wherein each of the plurality of steps comprise a generally vertical side wall joined at a bottom end thereof to the bottom wall of the measuring cup.

9. The measuring cup of claim 8, wherein each of the plurality of steps are of different heights to provide volumetric measurements of contents within the measuring cup.

10. The measuring cup of claim 9, wherein each of the plurality of steps is substantially triangular in shape.

11. The measuring cup of claim 1, wherein an outer surface of the side wall includes a plurality of bands.

12. The measuring cup of claim 11, wherein the plurality of bands are aligned with horizontal surfaces of the plurality of steps.

13. The measuring cup of claim 1, wherein an outer surface of the side wall includes a plurality of ledges.

14. The measuring cup of claim 13, wherein the plurality of ledges are aligned with horizontal surfaces of the plurality of steps.

15. The measuring cup of claim 1, wherein the plurality of steps are horizontally spaced apart.

16. The measuring cup of claim 1, wherein the plurality of steps are independently radially aligned.

17. A measuring cup comprising:
a bottom wall;
an upstanding encircling side wall having a bottom edge and an open upper end with a generally circularly shaped rim;
a plurality of steps being independently radially aligned on an inner surface of the side wall; and
each of the plurality of steps further including a horizontal upwardly forming surface marked with a volume indicia so as to be observable by a user looking downwardly towards the open upper end.

18. A measuring cup comprising:
a bottom wall connected to an upstanding encircling side wall to form an open upper end with an ellipsoidal rim defining a first and second corners; and
a plurality of horizontally spaced apart steps formed integrally with an inner surface of the side wall, wherein the plurality of horizontally spaced apart steps are not formed on either the first and second corners.

19. A measuring cup comprising:
a bottom wall;
a generally circular upstanding encircling side wall having a bottom edge and an open upper end; and
a plurality of steps formed integrally with an inner surface of the side wall, all of the plurality of steps being independently radially aligned.

20. A measuring cup comprising:
a bottom wall;
a generally circular upstanding encircling side wall having a bottom edge and an open upper end; and
a plurality of steps formed integrally with an inner surface of the side wall, each of the plurality of steps being horizontally spaced apart.

21. A measuring cup comprising:
a generally circularly shaped upstanding encircling side wall having a bottom edge and an open upper end;
a plurality of steps formed integrally with an inner surface of the side wall, each of the plurality of steps being non-vertically aligned; and
a bottom wall including a plurality of cut out portions, each of the plurality of cut out portions aligned with a corresponding one of the plurality of steps.
